(19) United States
(12) Patent Application Publication
(10) Pub. No.: US 2004/0029692 A1
(43) Pub. Date: Feb. 12, 2004

(54) Donor roll having a fluoropolymer layer

(75) Inventors: Christopher D. Blair, Webster, NY (US); Joy L. Longhenry, Webster, NY (US); Michelle L. Schlafer, Fairport, NY (US)

Correspondence Address: Patent Documentation Center, Xerox Corporation, Xerox Square 20th Floor, 100 Clinton Ave. S., Rochester, NY, 14644, US

(73) Assignee: Xerox Corporation

(21) Appl. No.: 10/217,198

(22) Filed: Aug. 9, 2002

(51) Int. Cl. B25F 5/02; F16C 13/00

(52) U.S. Cl. 492/59

(57) ABSTRACT

A donor roll for use in a development apparatus in an electrophotographic apparatus. The donor roll includes a core and an extruded layer comprising a fluoropolymer material. The core includes metal and has a length, and a periphery surface. The extruded layer comprising a fluoropolymer material, the layer having a length, thickness and a lumen therein for receiving at least a length of the core, the extruded layer comprising the fluoropolymer material is shrunken to substantially conform to the core. The donor roll may include a coating between the extruded layer and the core.

This invention relates to development apparatus and donor rolls.

Electrostatic reproduction involves uniformly charging a photoconductive member, or photoreceptor, to a substantially uniform potential, and then imagewise discharging it, or imagewise exposing it, based on light reflected from an original image that is being reproduced. The result is an electrostatically-formed latent image on the photoconductive member. The latent image is developed by bringing a charged developer material into contact with the photoconductive member.

Two-component developer materials comprise magnetic carrier particles and charged toner particles that adhere triboelectrically to the carrier particles and are intended to adhere the photoconductive member. A single-component developer material typically consists of only toner particles. The toner particles typically have an electrostatic charge to adhere to the photoconductive member, and magnetic properties to magnetically convey the toner particles from the sump to the magnetic roll. The toner particles adhere directly to the donor roll by electrostatic charges. The toner particles are attracted to the donor roll from a magnet or developer roll. From the donor roll, the toner is transferred to the photoconductive member in the development zone.

For both types of developer material, the charged toner particles are brought into contact with the latent image to form a toner image on the photoconductive member. The toner image is transferred to a receiver sheet, which then passes through a fuser device where the toner image is heated and permanently fused to the sheet, forming a hard copy of the original image.

A development device is used to bring the charged toner particles into contact with the latent image formed on the photoreceptor, so that the toner particles adhere electrostatically to the charged areas on the latent image. The development device typically includes a chamber in which the developer material is mixed and charged.

One type of a two-component development method and apparatus is known as “hybrid scavengeless development” (HSD), and is very suitable for image-on-image development type processes. In scavengeless development systems, toner is detached from the donor roll by applying an alternating current (AC) electric field to electrodes disposed between the donor roll and the photoconductive member. There is no physical contact between the development apparatus and the photoconductive member. Scavengeless development is useful in apparatus in which different types of toner are supplied to the same photoconductive member. Hybrid scavengeless development apparatus typically includes a mixing chamber that holds a two-component developer material containing carrier and toner particles, a magnetic roll, a donor member such as at least one rotatable donor roll, a development zone, and an electrode structure at the development zone between the donor roll and the photoconductive member. The donor roll receives charged toner particles from the developer roll and transports the particles to the development zone. An AC voltage is applied to the electrodes to form a toner cloud in the development zone. Electrostatic fields generated by an adjacent latent image on the photoconductive member surface attract charged toner particles from the toner cloud to develop the latent image on the photoconductive member.

Single component development systems, referred to as jumping gap development, can also use a donor roll for transporting charged toner particles directly from a toner chamber to the development zone. The charged toner particles similarly are attracted by and develop an electrostatic latent image recorded on a photoconductive surface. In jumping gap development, an AC voltage is applied to the donor roll for detaching toner particles from the donor roll and projecting them toward an adjacent photoconductive surface holding the electrostatic latent image.

In either of the above discussed development systems for example, the donor roll and its electrical and chemical characteristics are very important to the ability of the development apparatus to repeatably transport acceptable and uniform quantities of toner particles into the development zone, as well as effectively support the electrostatic fields necessary within the development zone for high quality image development. For example, the donor roll must be suitable for charged toner particles to effectively and controllably (even at high speeds) adhere electrostatically thereto. The surface of the donor roll must be partially conductive relative to a more conductive core, and this partial conductivity on the surface should be uniform throughout the entire circumferential surface area. The range of conductivity of a donor roll should be well chosen in order to maximize the efficiency of a donor roll in view of any number of designed parameters, such as energy consumption, mechanical control, and the discharge time-constant of the surface thereof.

In image-on-image type processes with a pre-developed toner image already on the photoreceptor, the donor roll should also act as an electrostatic “intermediate” between the photoreceptor and the developer transport roll in order to minimize unwanted interactions between the development system and the photoreceptor. Minimizing such interactions is particularly desirable in such processes because the single photoreceptor therein is to be charged, exposed and developed several times usually in a single, as in single pass highlight color process or in a single pass color process.

The donor roll must further have desirable wear-resistant properties so that the surface thereof will not be readily abraded by adjacent surfaces. Further, the surface of the donor roll should be without anomalies such as pin hoes, which may be created in the course of its manufacture. Pinholes created in the manufacturing process can result in electrostatic “hot spots” and undesirable electrical arcing in the vicinity of such structural imperfections.

Fuser rolls and pressure rolls including heat shrinkable tubing made of Polytetrafluoroethylene (PTFE), Perfluoroalkoxy (PFA), and Fluorinated Ethylene Propylene copolymer (FEP), and combinations thereof are known.

Reference is made to rolls, donor rolls and development systems in U.S. Pat. Nos. 6,412,175; 6,398,702; 6,340,528; 6,330,417; 6,327,452; 6,289,196; 6,253,053; 6,226,483; 6,212,349; 6,154,626; 6,141,873; 5,758,239; 5,731,078; 5,701,564; 5,600,414; 5,587,224; 5,473,418; 5,322,970; 5,245,392; 5,172,170; 4,619,517; 4,518,468 and 3,912,901.

All documents cited herein, including the foregoing, are incorporated herein by reference in their entireties.

In an embodiment, there is provided a donor roll for use in a development apparatus in an electrophotographic apparatus. The donor roll includes a core comprising metal and including a length, and a periphery surface; and an extruded layer comprising a fluoropolymer material, the layer having a length, thickness and a lumen therein for receiving at least a length of the core, the extruded layer comprising the fluoropolymer material substantially conforms to the core.

In another embodiment, there is provided a donor roll for use in an electrophotographic apparatus. The roll including a core including aluminum and having a length, a first end, a second end and an outer periphery surface; and an extruded tubular layer comprising a fluoropolymer material. The extruded tubular layer includes a length, a thickness ranging from 10 microns to 500 microns and a lumen therein for receiving at least a length of the core. The extruded tubular layer comprising the fluoropolymer material substantially conforms to the core after being heat shrunk.

In yet another embodiment, there is provided a donor roll including a core including a metal material. A coating material is disposed on the metal material. The core includes a length, a first end, a second end and an outer periphery surface. A layer comprising ethylene tetrafluoroethylene copolymer is disposed over the coating material. The layer comprising ethylene tetrafluoroethylene copolymer is an extruded tube heat shrinkable to the core.

In a further embodiment, there is provided a donor roll for use in a development apparatus in an electrophotographic apparatus. The donor roll including: (a) an aluminum core, the core including a length, a first end, and a second end; (b) a coating comprising ceramic disposed on at least a portion of the aluminum core; and (c) a tubular layer having a thickness, a diameter and a length, the tubular layer comprising a fluorocarbon material disposed on at least one of the aluminum core and the coating, the tubular layer comprising a fluorocarbon material layer contracted in diameter and shortened in length to substantially conform to at least one of the aluminum core and the coating.

In another embodiment, there is provided a method of making a donor roll comprising: providing a core including metal material, the core including a length, a first end, a second end and an outside periphery surface; providing a layer comprising a fluoropolymer material, the layer having a length, thickness and a lumen therein; inserting the core of metal material into the lumen of the layer comprising a fluoropolymer material such that the layer comprising the fluoropolymer material is situated over at least a portion of the core; and applying heat to at least a portion of the layer comprising the fluoropolymer material for a selected time and temperature to allow the layer comprising the fluoropolymer material to contract and conform to at least a portion of the outside periphery surface.

In an embodiment, there is provided a development system where a heat shrinkable sleeve comprising a fluoropolymer material such as ethylene tetrafluoroethylene copolymer (ETFE) is applied to a donor roll surface to reduce or prevent filming, a mechanical build-up of toner on the donor roll's surface hypothesized to be controlled by the donor roll's surface porosity and surface energy. The heat shrinkable sleeve will cover a core such as an aluminum member. A coating such as ceramic, described in U.S. Pat. Nos. 5,473,418 and 5,600,414, may be used between the aluminum and the fluoropolymer layer. The layer may combat the coating's porosity and lower its' surface energy. For example, a donor roll with ETFE sleeve will have the electrical properties required for toner movement, with surface properties to prevent or reduce filming. In addition to advantages of low surface energy and little or no porosity, the ETFE sleeve is a generally tough material. The toughness of ETFE also provides abrasion resistance that is needed for the development process. Furthermore, the resistivity and dielectric strength properties of the ETFE material are on the order of that needed for HSD development. Ethylene Tetrafluoroethylene copolymer is available commercially under the tradename Tefzel® from E. I. du Pont de Nemours and Company. ETFE may be doped with carbon particles to control the resistivity of the material.

It is desirable to provide an improved donor roll including an ETFE layer for use in a Hybrid Scavengeless Development (HSD) system that will be suitable for charged toner particles to effectively and controllably adhere electrostatically thereto. Furthermore, also provide a surface that enables reduced mechanical adhesion of toner to the roll surface, for example, filming. Filming of toner on the roll's surface reduces the surface conductivity which eventually affects print quality. It is believed some roll coatings have a natural porosity and high surface energy which contribute to this filming phenomenon. The filming may also reduce the life of the donor roll which may require replacement at a much higher rate.

In embodiments, an extruded tube is provided having a selected length and a thickness of 225-275 microns although other ranges of thickness are envisioned. In embodiments, the sleeve may have a thickness of 250 microns or of a thickness, diameter, and length selected for fit and function. A heat shrinkable tube is fit over the uncoated or coated donor roll core. A heat gun or other heating process can be used to shrink the tube to closely conform to the underlying core. It is envisioned that a layer of fluoropolymer material may also be applied to the roll in sheet form which would involve one or more seams. The sleeve may require trimming and machining of the outside periphery as required to provide a desired size and finish. An ETFE tube may have a tensile strength of the range from 5.8 to 6.7 Kpsi; the flexural modulus may be about 170 Kpsi; and the hardness may be about Shore D 72.

In embodiments, it is envisioned that other fluoropolymer materials including High Density Polyethylene (HDPE), Polytetrafluoroethylene (PTFE), Perfluoroalkoxy (PFA), Polyvinylidenefluoride (PVDF), Fluorinated Ethylene Propylene copolymer (FEP), Chloro-trifluoroethylene (CTFE), Ethylene Tetrafluorethylene (ETFE) copolymer, and combinations thereof may be used as a layer in embodiments of the donor roll. The fluoropolymer materials may be commercially available from various suppliers including, for example, Saint Gobain, Daikin, or E. I. du Pont de Nemours and Company.

Still other aspects and features will become readily apparent to those skilled in the art from the following detailed description, wherein embodiments are shown and described, simply by way of illustration. As will be realized, the invention is capable of other and different embodiments, and its details are capable of modification and interchangeability in various respects. Accordingly, the drawing and description are to be regarded as illustrative in nature, and not as restrictive.

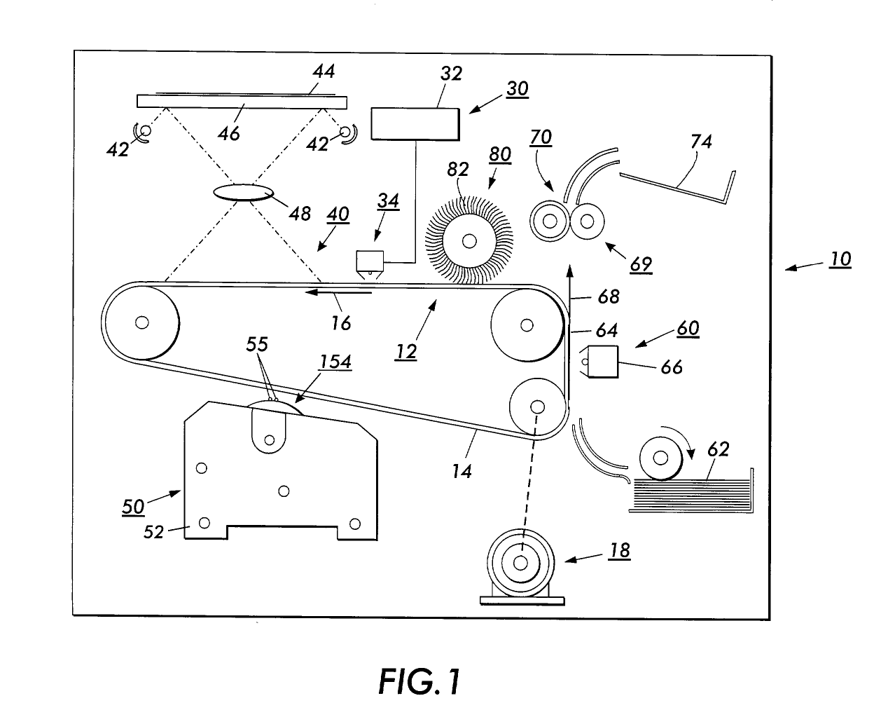

FIG. 1 illustrates a scavengeless electrostatographic development apparatus including an embodiment of a donor roll;

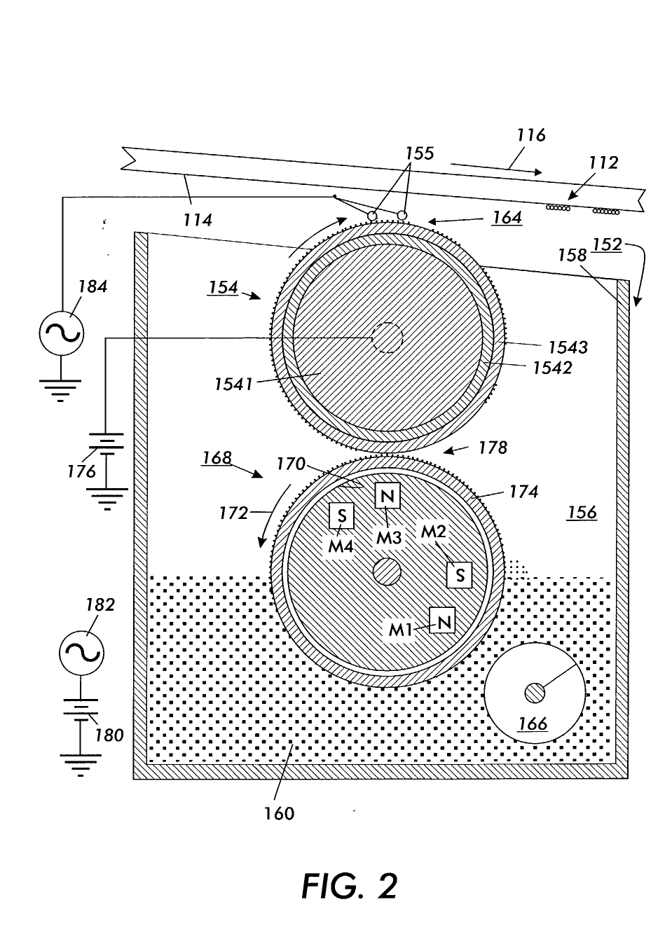

FIG. 2 illustrates a two-component, hybrid scavengeless development device including an embodiment of a donor;

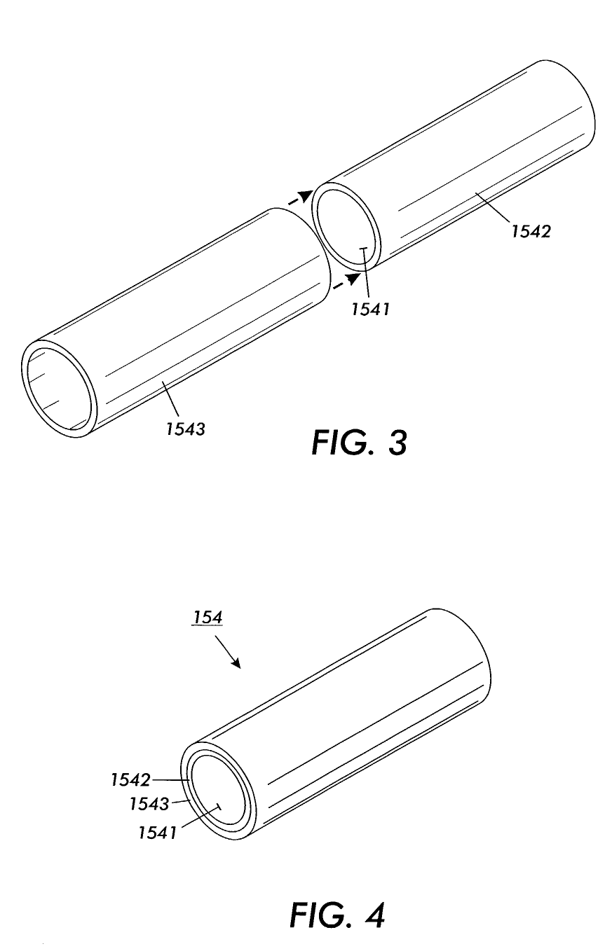

FIG. 3 illustrates a core and sleeve of an embodiment of a donor roll;

FIG. 4 illustrates an embodiment of a donor roll according to this invention; and

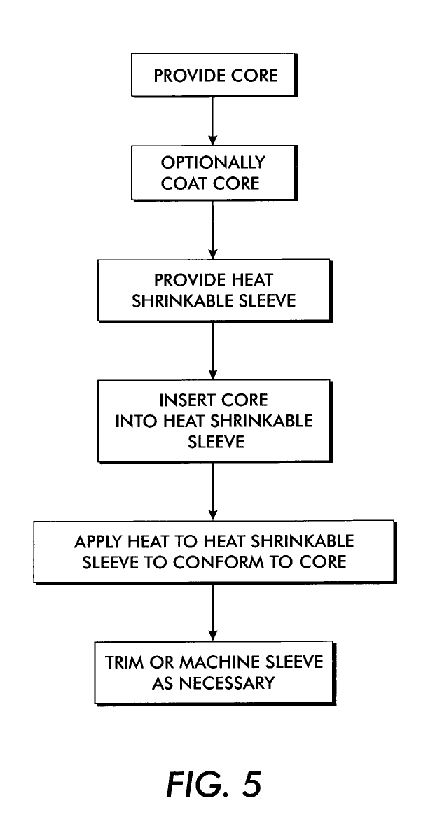

FIG. 5 illustrates a process of making an embodiment of a donor roll.

Disclosed in the Figures are examples of an improvement in donor rolls. FIG. 1 shows an embodiment of a scavengeless electrostatic imaging apparatus 10 including an embodiment of a donor roll 154. The imaging apparatus 10 includes an image bearing member in the form of a belt 12 having an outer photoconductive surface 14. The image bearing member can alternatively comprise other types of photoconductive image bearing members, such as a drum having a photoconductive surface. The belt 12 moves in the direction of the arrow 16 to advance successive portions of the photoconductive surface 14 sequentially through various processing stations during the imaging process. The belt 12 is driven by a motor 18.

Initially, a portion of the belt 12 passes through a charging station 30 where a power supply 32 causes the corona generating device 34 to charge a portion of the photoconductive surface 14 of the belt 12.

The charged portion of the belt 12 is advanced to an exposure station 40. At the exposure station 40, one or more light sources such as lamps 42 emit light that is reflected onto an original document 44 seated on a transparent platen 46. The light reflected imagewise from the original image of the document 44 is transmitted through a lens 48. The lens 48 focuses the imagewise light onto the charged portion of the photoconductive surface 14 to selectively dissipate the charge to form a latent image. The latent image formed on the photoconductive surface 14 corresponds to the informational areas contained within the original image of the document 44. For such imagewise exposure of the photoconductive surface 14 in a digital copier, a laser printer and the like, a raster output scanner (ROS) can alternatively be used instead of the lamps 42 and lens 48.

After the electrostatic latent image is formed on the photoconductive surface 14, the belt 12 advances the latent image to a development station 50. At the development station 50, a development apparatus 52 develops the latent image recorded on the photoconductive surface 14 to form a toner image.

The belt 12 then advances the toner image to a transfer station 60 where a copy sheet 62 is advanced by a sheet feeding apparatus 64 to transfer the toner image to the sheet 62. The transfer station 60 also includes a corona generating device 66, which sprays ions onto the sheet 62 to attract the toner image from the photoconductive surface 14 onto the sheet 62. After this image transfer, the sheet 62 is separated from the belt 12 and moved in the direction of the arrow 68 by rollers 69 to a fusing station 70.

The fusing station 70 includes a fuser assembly that heats, fuses and permanently affixes the toner image to the sheet 62, forming a sheet copy of the original image of document 44. The sheet 62 is then advanced to a tray 74.

The belt 12 moves the portion of the surface 14 from which the image had been transferred to the sheet 62 to a cleaning station 80. The cleaning station 80 can include a brush 82 or the like that rotates in contact with the photoconductive surface 14 to remove the residual toner particles. Next, light is emitted onto the photoconductive surface 14 to dissipate any residual electrostatic charge on the belt 12.

FIG. 2 shows an embodiment of hybrid scavengeless two-component development apparatus 152 including an embodiment of a donor roll 154. The donor roll 154 is mounted partially within a mixing chamber 156 defined by a housing 158. The mixing chamber 156 holds a supply of a two-component developer material 160 comprising toner particles and carrier beads. The donor roll 154 transports toner particles that have been fed from the mixing chamber 156 into contact with electrode wires 155 within a development zone 164 for latent image development. The developer material 160 is moved and mixed within the mixing chamber 156 by a mixing device 166 to charge the carrier beads and toner particles. The oppositely charged toner particles adhere triboelectrically to the charged magnetizable carrier beads.

The development apparatus 152 also includes a developer material feeder assembly, such as a magnetic roll 168, that feeds a quantity of the developer material 160 from the mixing chamber 156 to the donor roll 154. The magnetic roll 168 includes a substrate 170. The substrate 170 rotates in the direction of the arrow 172, and includes a coating 174, and magnetic members M1 to M4. The magnetic roll 168 and the donor roll 154 are electrically biased relative to each other so that charged toner particles of the developer material 160 fed to the donor roll 154 are attracted from the magnetic roll 168 to the donor roll 154.

In some other embodiments, the coating 174 is not needed on the substrate 170 to provide the desired transport properties. In addition, the substrate 170 can include a different number of magnetic members than the four magnetic members M1 to M4 in FIG. 2.

As also shown in FIG. 2, the donor roll 154 is biased to a specific voltage by a direct current (DC) power supply 176 so that the donor roll 154 attracts charged toner particles from the magnetic roll 168 in a nip 178. To enhance the attraction of charged toner particles from the mixing chamber 156, the magnetic roll 168 is also biased by a DC voltage source 180. The magnetic roll 168 is also biased by an AC voltage source 182 that temporarily loosens the charged toner particles from the magnetized carrier beads. The loosened charged toner particles are attracted to the donor roll 154. An AC bias is also applied to the electrode wires 155 by an AC voltage source 184 to loosen charged toner particles from the donor roll 154, and to form a toner cloud within the development zone 164.

Other embodiments of the hybrid scavengeless two-component development apparatus 152 can comprise more than one donor roll 154, such as, for example, two donor rolls 154. Such apparatus can also include more than one magnetic roll 168 and more than one mixing device 166. The donor roll 154 can also be used in scavengeless single-component development apparatus.

As shown in FIGS. 3-4, an embodiment of the donor roll 154 includes a core 1541, an outer surface coating 1542 and a fluoropolymer layer 1543. The core 1541 may comprise any suitable material that has desired electrical conducting properties. The material forming the core 1541 should be able to withstand the temperatures that are typically reached during a process of coating the core 1541, as described below. The core 1541 can be formed, for example, of metallic materials. Ferrous materials such as steels and stainless steels can be used to form the core 1541. In addition, non-ferrous materials such as aluminum and aluminum alloys, and copper-based materials such as brass, can be used to form the core 1541.

In an embodiment, a donor roll 154 may include a core 1541 comprising aluminum and a fluoropolymer layer 1543 disposed over the core 1541 in which the fluoropolymer layer 1543 is shrunk and substantially conforms to the shape of the outer periphery of the core 1541. The aluminum core 1541 includes a length, a first end, a second end and an outer periphery surface. The core 1541 is typically cylindrical shaped.

Reference is made to FIG. 5 illustrating an embodiment of a process of making an embodiment of the donor roll including: providing a core; optionally coating the core; providing a heat shrinkable sleeve or tube such as a fluoropolymer material; inserting the core into the sleeve or tube; and applying heat to the sleeve or tube to conform to the core; and trimming or machining the sleeve or tube.

Further, non-metallic materials such as glass, fiber-reinforced resins, composites, ceramics and high-temperature plastics may be used in the core 1541. For the non-metallic core materials, the core 1541 and coating 1542 are electrically grounded. The coating 1542 may comprise a ceramic material. In certain embodiments of the donor roll 154, the coating 1542 may include alumina titania, stabilized zirconium oxide, or zirconia, or glass. Suitable zirconia and alumina titania materials for forming the coating 1542 are commercially available from Saint Gobain of Worchester, Mass. Reference is made to U.S. patent application Ser. No. 09/584,373, Roll Having Glass Coating, filed May 31, 2000; and U.S. Pat. Nos. 5,473,418; 5,600,414; and 6,398,702.

The composition of the coating 1542 can be selected to provide the desired electrical properties to the donor roll 154. These electrical properties include electrical resistivity, which is the inverse of electrical conductivity, and breakdown voltage protection.

The ceramic coating 1542 can be applied onto the core 1541 by any suitable coating process such as a thermal spray process. For example, the coating 1542 can be applied by plasma spraying. A suitable plasma spraying device for applying the coating 1542 is a Praxair SG100 plasma spray gun commercially available from Praxair Surface Technologies of Appleton, Wis. Suitable arc gases for the plasma spraying process include argon and helium. Hydrogen may also be used. Suitable process parameters, including the gas flow rates, energy level, powder feed rate and plasma spraying device standoff distance, can be selected to provide the desired characteristics of the coating 1542. However, it is to be noted that even though plasma spraying is a thermal spray process for depositing the ceramic coating, other thermal spraying processes, such as high-velocity oxy-fuel (HVOF) processes, can also be used to form the coating 1542 on the core 1541.

The coating 1542 can be applied to cover substantially the entire outer surface of the core 1541. In some embodiments, however, it may be desirable to coat most of the outer surface of the core 1541, but to leave selected uncoated regions on the outer surface of the core 1541, such as near the ends of the roll 154. The ends or faces of the core 1541 are typically also coated.

The thickness of the ceramic coating 1542, for example, is preferably between 0.17 and 0.5 mm, on a core 1541. Ceramic coated donor rolls can have electrical resistivity of about 10³ ohm-cm to 10¹⁰ ohm-cm. In some exemplary embodiments of the donor roll, the preferred coating has an electrical resistivity of 10⁸ ohm-cm.

The coating 1542 is applied onto the core 1541 after a suitable surface finish has been formed on the core 1541. Typically, the core 1541 outer surface is prepared, such as by grit blasting, to provide a suitable surface for applying the coating 1542 onto the core 1541. A suitable roughness of the surface of the core 1541 on which the coating 1542 is applied is typically about 3 microns or more. This roughness level of the surface of the core 1541 is typically suitable to achieve sufficient mechanical interlocking with the coating 1542 to provide good adhesion.

In embodiments, a bond coat can be applied on the core 1541 to enhance adhesion of the coating 1542 on the core 1541. The bond coat can also increase the resistance of the coating 1542 to cracking or other defects during cooling after the coating process of the coating 1542. The bond coat can comprise any suitable material, such as a mixture of chrome-aluminum-yttrium-cobalt, or a mixture of nickel-aluminum powder.

In some exemplary embodiments, the donor roll 154 can also comprise a protective overcoat applied over the coating 1542. Suitable overcoats are described in U.S. Pat. No. 6,226,483. The overcoat is applied to prevent, or at least reduce the effects of, wear and moisture penetration. In addition, the overcoat can be applied to tune the physical properties and performance characteristics of the coating 1542, including, for example, friction and conductivity. Suitable exemplary overcoat materials include waxes, polymeric resins and metal oxides.

The cooling rate of the coating 1542 can be controlled to reduce the thermal differential between the core 1541 and the coating 1542, to thereby reduce the generation of thermal stresses in the coating 1542. Cooling can be controlled by directing a gas flow onto the core 1541 during the coating process. In addition, the core 1541 can be preheated to a suitable temperature to reduce the thermal differential between the core 1541 and the coating 1542. Preheating the core 1541 also promotes the adhesion of the coating 1542. Typically, the temperature of the core 1541 and the coating 1542 are maintained below about 300 degrees F. to achieve a suitable thermal differential and good coating adhesion.

The thickness of the coating 1542 as formed on the core 1541 by the thermal spraying process is typically from about 75 microns to about 450 microns. In some exemplary embodiments of the donor roll 154, the coating 1542 may have a thickness of from about 100 microns to about 400 microns as applied on the respective core 1541.

An unfinished donor roll may have an arithmetic mean roughness Ra of from about 3 microns to about 7 microns. This surface smoothness level may not be completely satisfactory for some high-precision electrostatographic development applications. Accordingly, in some exemplary embodiments of the coating 1542, the coating 1542 formed on the respective core 1541 by a thermal spraying process is finished by a machining process to achieve a desired final finish having a suitable low roughness. The coating 1542 provides the advantage that a highly smooth surface finish can be formed using known grinding and polishing techniques. Typically, the coating 1542 can be finished using a suitable grinding device and abrasive material, such as by diamond grinding, to achieve the desired surface roughness. In such embodiments, the final thickness of the coating 1542 is less than its applied thickness. Accordingly, the applied thickness of the coating 1542 is selected to compensate for the coating material that is removed by the finishing process.

In embodiments, the core may include glass, fiber-reinforced ceramics, composites, ceramics and high-temperature plastics. The roll may be a donor roll. A bond coat including an adhesive between the core and the outer layer may be used to enhance adhesion of the outer layer to the core. An overcoat may be formed over the layer. The layer may be heat shrinkable. The core may include an electrically conductive material. The core may include a ceramic material. The core may include glass, fiber-reinforced ceramics, composites, ceramics, high-temperature plastics, aluminum, aluminum alloys or copper-based materials. The core may include aluminum and a ceramic coating on the aluminum. The layer may be a heat shrinkable extruded tube. The tube may be disposed over the outside periphery surface of the core and have an inside surface and an outside surface where the inside surface of the tube closely conforms to the outside surface of the roll. The extruded layer comprising the fluoropolymer material may be heat shrunk on the core and have a thickness in the range of from 10 microns to 500 microns after being heat shrunk on the core. The extruded layer comprising the fluoropolymer material may be selected from the group consisting of High Density Polyethylene (HDPE), Polytetrafluoroethylene (PTFE), Perfluoroalkoxy (PFA), Polyvinylidenefluoride (PVDF), Fluorinated Ethylene Propylene copolymer (FEP), Chlorotrifluoroethylene (CTFE), Ethylene Tetrafluorethylene (ETFE) copolymer, and combinations thereof. The extruded tube may be disposed over an outside surface of at least one of the core and the coating material. The extruded tube may have an inside surface and an outside surface in which the inside surface of the extruded tube closely conforms to the outside surface of at least one of the core and the coating material. The tubular layer may have a tensile strength in the range from 3.0 Kpsi to 6.7 Kpsi. The fluoropolymer material may be melt processable. The method of making a donor roll may include: trimming or machining the layer; providing an aluminum material; forming a coating on the core prior to inserting the core of metal material into the lumen of the layer comprising a fluoropolymer material.

As described above, the fluoropolymer layer 1543 may be used for donor rolls 154 and be used in various types of scavengeless development systems, including both single and double-component developer material systems.

However, it will be appreciated by those skilled in the art that the fluoropolymer layer 1543 can be also be formed on other type of rolls used in imaging, copying and printing apparatus, including color printing, that would benefit from a layer having controlled electrical properties, as well as improved development properties. Such other types of rolls can be included in various types of analog and digital electrostatographic imaging apparatus.

While the invention has been described in conjunction with the specific embodiments described above, it is evident that many alternatives, equivalents, modifications and variations are apparent to those skilled in the art. Accordingly, the embodiments set forth above are intended to be illustrative and not limiting. Various changes can be made without departing from the spirit and scope of the invention.

What is claimed is:

1. A donor roll for use in a development apparatus in an electrophotographic apparatus, the donor roll comprising:
a core comprising metal and including a length, and a periphery surface; and
an extruded layer comprising a fluoropolymer material, the layer having a length, thickness and a lumen therein for receiving at least a length of the core, the extruded layer comprising the fluoropolymer material substantially conforms to the core.

2. The donor roll of claim 1 wherein the extruded layer comprising the fluoropolymer material is heat shrunk on the core and has a thickness in the range of from 10 microns to 500 microns after being heat shrunk on the core.

3. The donor roll of claim 2 wherein the extruded layer comprising the fluoropolymer material is selected from the group consisting of High Density Polyethylene (HDPE), Polytetrafluoroethylene (PTFE), Perfluoroalkoxy (PFA), Polyvinylidenefluoride (PVDF), Fluorinated Ethylene Propylene copolymer (FEP), Chloro-trifluoroethylene (CTFE), Ethylene Tetrafluorethylene (ETFE) copolymer, and combinations thereof.

4. The donor roll of claim 1 wherein the core includes aluminum and a ceramic coating on the aluminum.

5. The donor roll of claim 1, wherein the core includes a coating material selected from the group consisting of glass, fiber-reinforced ceramics, composites, ceramics and high-temperature plastics.

6. The donor roll of claim 2, further comprising an adhesive between the core and the extruded layer.

7. The donor roll of claim 1, wherein the core comprises an electrically conductive material.

8. A donor roll for use in an electrophotographic apparatus comprising:
a core including aluminum, the core including a length, a first end, a second end and an outer periphery surface; and
an extruded tubular layer comprising a fluoropolymer material, the extruded tubular layer having a length, a thickness ranging from 10 microns to 500 microns and a lumen therein for receiving at least a length of the core, the extruded tubular layer comprising the fluoropolymer material substantially conforms to the core after being heat shrunk.

9. The donor roll of claim 8 wherein the layer comprising the fluoropolymer material is in an extruded tubular form having a length and a lumen therein and is selected from the group consisting of High Density Polyethylene (HDPE), Polytetrafluoroethylene (PTFE), Perfluoroalkoxy (PFA), Polyvinylidenefluoride (PVDF), Fluorinated Ethylene Propylene copolymer (FEP), Chloro-trifluoroethylene (CTFE), Ethylene Tetrafluorethylene (ETFE) copolymer, and combinations thereof.

10. A donor roll comprising:
a core including a metal material;
a coating material disposed on the metal material, the core including a length, a first end, a second end and an outer periphery surface; and
a layer comprising ethylene tetrafluoroethylene copolymer disposed over the coating material,
wherein the layer comprising ethylene tetrafluoroethylene copolymer is an extruded tube heat shrinkable to the core.

11. The donor roll of claim 10, wherein the coating material is selected from the group consisting of glass, fiber-reinforced ceramics, composites, ceramics and high-temperature plastics.

12. The donor roll of claim 10, wherein the core comprises an electrically conductive material.

13. The donor roll of claim 10, wherein the core includes a material selected from the group consisting of aluminum, aluminum alloys and copper-based materials.

14. The donor roll of claim 10, wherein the extruded tube is disposed over an outside surface of at least one of the core and the coating material, the extruded tube having an inside surface and an outside surface, wherein the inside surface of the extruded tube closely conforms to the outside surface of at least one of the core and the coating material.

15. A donor roll for use in a development apparatus in an electrophotographic apparatus, the donor roll comprising:
(a) an aluminum core, the core including a length, a first end, and a second end;
(b) a coating comprising ceramic disposed on at least a portion of the aluminum core; and
(c) a tubular layer having a thickness, a diameter and a length, the tubular layer comprising a fluorocarbon material disposed on at least one of the aluminum core and the coating, the tubular layer comprising a fluorocarbon material layer contracted in diameter and shortened in length to substantially conform to at least one of the aluminum core and the coating.

16. The donor roll of claim 15 wherein the tubular layer is in an extruded form and includes a thickness ranging from 10 microns to 500 microns and is selected from the group consisting of High Density Polyethylene (HDPE), Polytetrafluoroethylene (PTFE), Perfluoroalkoxy (PFA), Polyvinylidenefluoride (PVDF), Fluorinated Ethylene Propylene copolymer (FEP), Chlorotrifluoroethylene (CTFE), Ethylene Tetrafluorethylene (ETFE) copolymer, and combinations thereof.

17. The donor roll of claim 16 wherein the tubular layer has a tensile strength in the range from 3.0 Kpsi to 6.7 Kpsi.

18. A method of making a donor roll comprising:
providing a core including metal material, the core including a length, a first end, a second end and an outside periphery surface;
providing a layer comprising a fluoropolymer material, the layer having a length, thickness and a lumen therein;
inserting the core of metal material into the lumen of the layer comprising a fluoropolymer material such that the layer comprising the fluoropolymer material is situated over at least a portion of the core; and
applying heat to at least a portion of the layer comprising the fluoropolymer material for a selected time and temperature to allow the layer comprising the fluoropolymer material to contract and conform to at least a portion of the outside periphery surface.

19. The method of making a donor roll of claim 18, wherein the providing the layer comprising the fluoropolymer material further includes providing a heat shrinkable tube made of a material selected from the group consisting of High Density Polyethylene (HDPE), Polytetrafluoroethylene (PTFE), Perfluoroalkoxy (PFA), Polyvinylidenefluoride (PVDF), Fluorinated Ethylene Propylene copolymer (FEP), Chloro-trifluoroethylene (CTFE), Ethylene Tetrafluorethylene (ETFE) copolymer, and combinations thereof.

20. The method of making a donor roll of claim 19, further comprising at least one of trimming and machining the layer.

21. The method of making a donor roll of claim 20, wherein the providing a core of metal material further includes providing an aluminum material.

22. The method of making a donor roll of claim 21, further comprising forming a coating on the core prior to inserting the core of metal material into the lumen of the layer comprising a fluoropolymer material.

23. The method of making a donor roll of claim 18, wherein the fluoropolymer material is melt processable.
